(19) United States
(12) Patent Application Publication
(10) Pub. No.: US 2020/0109459 A1
(43) Pub. Date: Apr. 9, 2020

(54) VEHICLE UNDERBODY PART MATERIAL, METHOD FOR MANUFACTURING VEHICLE UNDERBODY PART MATERIAL, AND METHOD FOR MANUFACTURING VEHICLE UNDERBODY PART

(71) Applicant: NIPPON STEEL CORPORATION, Tokyo (JP)

(72) Inventor: Toyomitsu NAKAMURA, Tokyo (JP)

(73) Assignee: NIPPON STEEL CORPORATION, Tokyo (JP)

(21) Appl. No.: 16/500,777

(22) PCT Filed: Apr. 11, 2018
(86) PCT No.: PCT/JP2018/015240

§ 371 Date: Oct. 3, 2019

(30) Foreign Application Priority Data
Apr. 12, 2017 (JP) 2017-079022

(51) Int. Cl. C21D 9/08; C22C 38/32; C22C 38/28; C22C 38/06; C22C 38/04; C22C 38/02; C22C 38/00; C22C 18/04; C22C 30/06; B32B 1/08; B32B 15/01; C23C 2/06; C23C 2/28; C23C 2/38; C21D 6/00; C21D 1/18; B21D 7/16; B62D 29/00

(52) U.S. Cl. CPC C21D 9/085; B62D 29/007; C22C 38/28; C22C 38/06; C22C 38/04; C22C 38/02; C22C 38/002; C22C 18/04; C22C 30/06; B32B 1/08; B32B 15/013; C23C 2/06; C23C 2/28; C23C 2/38; C21D 6/008; C21D 6/005; C21D 6/002; C21D 1/18; B21D 7/162; C22C 38/32

(57) ABSTRACT

To provide a technique capable of preventing or suppressing fatigue failure of a vehicle underbody part material by 3DQ. A vehicle underbody part material relating to this disclosure includes: a quenched and bent steel pipe; and a plating film layer provided on a surface of the steel pipe and containing 30 mass % or more of Al and having an Al—Fe alloy existing in a surface thereof.

### TECHNICAL FIELD

This disclosure relates to a vehicle underbody part material, a method for manufacturing a vehicle underbody part material, and a method for manufacturing a vehicle underbody part.

### BACKGROUND ART

A steel material for a vehicle structure is required to have a light weight and a tensile strength of 780 MPa or more in consideration of the global environment. In recent years, it is strongly required to have a high strength at a level completely different from the conventional one, such as a tensile strength of 900 MPa or more. Further, to enhance the safety of the vehicle at collision to improve the safety, a development for enhancing the energy absorption characteristics of a vehicle member at collision is also promoted. In particular, there are disclosed inventions for manufacturing molded products having optimal shapes composed of, for example, a wide variety of bent shapes having a bending direction changing in an arbitrary direction using a steel pipe or a steel sheet as a material.

In the following Patent Document 1, there is disclosed a bending method for, even in the case of continuous bending in which the bending of the steel material changes in an arbitrary direction and size (three-dimensionally), efficiently performing the bending using movable roller dies freely changeable in position and posture and performing the quenching of the steel material concurrently with the bending. In this description, the bending method is abbreviated to “3DQ: 3 Dimensional hot bending and Quench”. In 3DQ, the steel material being a workpiece is rapidly heated up to an Ac3 transformation point in the atmosphere by a high-frequency heating coil and immediately thereafter rapidly cooled to be quenched. In addition, a bending moment is applied by the movable roller dies to a portion heated to be high temperature and thus reduced in deformation resistance, thereby plastically deform the portion reduced in deformation resistance.

A bending moment application unit of the 3DQ apparatus is not limited to the movable roller dies. In the following Patent Document 2, there is disclosed a 3DQ apparatus that grasps a steel material by a chuck and moves the chuck by a multi joint robot or the like to apply a bending moment.

In recent years, a member by 3DQ is used for structural materials of a vehicle such as a cross member, a door impact bar, and an A pillar. Other than the above, a vehicle underbody part material (an arm material) by 3DQ is disclosed in the following Patent Document 3.

### PRIOR ART DOCUMENT

### Patent Document

Patent Document 1: International Publication No. WO 2006/093006

Patent Document 2: Japanese Laid-open Patent Publication No. 2015-98060

Patent Document 3: International Publication No. WO 2010/055747

### DISCLOSURE OF THE INVENTION

### Problems to be Solved by the Invention

However, the arm material disclosed in the above Patent Document 3 has a problem of breakage in a fatigue test. A main object of this description is to provide a technique capable of preventing or suppressing fatigue failure of a vehicle underbody part material by 3DQ.

### Means for Solving the Problems

The present inventors have come to obtain the following invention as a result of an earnest study of a method for applying 3DQ while preventing or suppressing the occurrence of fatigue failure.

(1) A vehicle underbody part material including: a quenched and bent steel pipe; and a plating film layer provided on a surface of the steel pipe and containing 30 mass % or more of Al and having an Al—Fe alloy existing in a surface thereof.

(2) The vehicle underbody part material according to (1), wherein a surface roughness of the plating film layer is 3.5 μm or less in arithmetic mean roughness Ra specified under JIS B0601: 2013.

(3) The vehicle underbody part material according to (1) or (2), wherein an outermost layer of the plating film layer is composed of (30 to 60) mass % Al—Zn—(0 to 2.5) mass % Si—(0 to 5) mass % Mg—(20 to 50) mass % Fe hot-dip plating.

(4) The vehicle underbody part material according to (1) or (2), wherein an outermost layer of the plating film layer is composed of Al—(0 to 15) mass % Si—(20 to 70) mass % Fe hot-dip plating.

(5) The vehicle underbody part material according to any one of (1) to (4), wherein the Al—Fe alloy is at least one of FeAl, Fe_{0.4}Al_{0.6}, FeAl₂, Fe₂Al₅, and FeAl₃.

(6) A method for manufacturing a vehicle underbody part material including: heating a part of a steel pipe including a plating film layer containing 30 mass % or more of Al in a surface thereof at an average temperature increasing rate of 100° C./sec or more from 100° C. to a maximum heating temperature in a range of 850 to 1300° C.; bending a part of the steel pipe having reached the maximum heating temperature; and cooling the part of the steel pipe at an average cooling rate of 1000° C./sec or more and to an ultimate temperature of 350° C. or lower within two seconds after the part of the steel pipe has reached the maximum heating temperature.

(7) The method for manufacturing the vehicle underbody part material according to (6), wherein the plating film layer has an Al—Fe alloy existing in the surface thereof.

(8) The method for manufacturing the vehicle underbody part material according to (7), wherein an outermost layer of the plating film layer is composed of (30 to 60) mass % Al—Zn—(1 to 2.5) mass % Si—(0 to 5) mass % Mg—(20 to 50) mass % Fe hot-dip plating.

(9) The method for manufacturing the vehicle underbody part material according to (7), wherein an outermost layer of the plating film layer is composed of Al—(0 to 15) mass % Si—(20 to 70) mass % Fe hot-dip plating.

(10) The method for manufacturing the vehicle underbody part material according to any one of (7) to (9), wherein the Al—Fe alloy is produced by heating, in a furnace, a material steel pipe including a plating film layer containing 50 mass % or more of Al to 750° C. or higher and 900° C. or lower.

(11) The method for manufacturing the vehicle underbody part material according to (10), wherein an outermost layer of the plating film layer of the material steel pipe is composed of (50 to 60) mass % Al—Zn—(1 to 2.5) mass % Si—(0 to 5) mass % Mg hot-dip plating.

(12) The method for manufacturing the vehicle underbody part material according to (10), wherein an outermost layer of the plating film layer of the material steel pipe is composed of Al—(0 to 15) mass % Si hot-dip plating.

(13) The method for manufacturing the vehicle underbody part material according to any one of (7) to (12), wherein the Al—Fe alloy is at least one of FeAl, Fe_{0.4}Al_{0.6}, FeAl₂, Fe₂Al₅, and FeAl₃.

(14) A method for manufacturing a vehicle underbody part of manufacturing the vehicle underbody part from the vehicle underbody part material according to any one of (1) to (5) or the vehicle underbody part material manufactured by the method for manufacturing the vehicle underbody part material according to any one of (6) to (13).

### Effect of the Invention

According to this disclosure, it is possible to provide a technique capable of preventing or suppressing fatigue failure of a vehicle underbody part material by 3DQ.

### BRIEF DESCRIPTION OF THE DRAWINGS

FIG. 1A is an explanatory view illustrating a configuration of a 3DQ apparatus disclosed in Patent Document 2.

FIG. 1B is an explanatory view illustrating the configuration of the 3DQ apparatus disclosed in Patent Document 2.

FIG. 2 is an explanatory view illustrating a configuration of a 3DQ apparatus disclosed in Patent Document 1.

FIG. 3A is an explanatory view illustrating a vehicle underbody part material according to an embodiment of this disclosure.

FIG. 3B is an explanatory view illustrating a cross-sectional structure of the vehicle underbody part material according to the same embodiment.

FIG. 4A is a photograph illustrating an external appearance of a test material of No. 3 of Test Example 2.

FIG. 4B is a photograph illustrating an external appearance of a test material of No. 8 of Test Example 2.

### EMBODIMENTS FOR CARRYING OUT THE INVENTION

Hereinafter, preferable embodiments of this disclosure will be explained in detail referring to the accompanying drawings. Note that, in the description and the drawings, the same codes are given to components having substantially the same functional configurations to omit duplicated explanation.

<Regarding Fatigue Failure of a Member Manufactured by 3DQ>

When a fatigue test is performed on a member manufactured by 3DQ to apply a load 1.5 million times, the member may cause fatigue failure. Through the analysis of a fracture surface caused by the fatigue failure, inclusion of Cu was observed on the fracture surface, so that Cu is considered to influence the fatigue failure. Cu is not intentionally made to adhere to a steel material which is subjected to 3DQ, so that Cu is considered to have been mixed therein from somewhere.

When Cu (including a Cu alloy including brass) exists on a surface of a steel pipe in passing the steel material (for example, the steel pipe) through a heating mechanism in a 3DQ manufacturing apparatus for performing 3DQ, Cu melts and the melted Cu dissolves into a crystal grain boundary of the steel pipe to thereby weaken the crystal grain boundary. When a tensile stress is applied to the weakened crystal grain boundary, the grain boundary breaks to cause the fatigue failure.

By manufacturing a vehicle underbody part material by 3DQ using the steel pipe having a plating film layer containing Al as a workpiece according to this disclosure explained below in detail, it becomes possible to obtain a vehicle underbody part material excellent in fatigue resistance.

<Regarding a Material Steel Pipe>

First, a steel pipe used in the method for manufacturing a vehicle underbody part material according to the embodiment of this disclosure will be explained. As illustrated below, the steel pipe used in the method for manufacturing the vehicle underbody part material is a surface-treated steel pipe having a plating film layer containing 50 mass % or more of Al formed on a steel pipe being a material.

(Configuration of the Material Steel Pipe)

The surface of the material steel pipe being a material of the vehicle underbody part material according to this embodiment includes the following plating film layer. Heating and cooling the material steel pipe using 3DQ according to the conditions explained below in detail can manufacture a high-strength vehicle underbody part material having fatigue resistance.

For a steel pipe being a base material of the plating film layer in the material steel pipe, a steel material having a quenching property is used. A low-strength steel pipe is used as a starting material and the following plating film layer is provided on the surface of the steel pipe to form the material steel pipe. The material steel pipe is subjected to heating and cooling under the conditions explained below in detail and thereby quenched. This can increase the tensile stress, for example, to 1200 MPa or more to manufacture the high-strength vehicle underbody part material.

As the steel pipe of the material having the quenching property, for example, a steel pipe is exemplified which has a chemical composition, by mass %, C: 0.1% or more and 0.3% or less, Si: 0.01% or more and 0.5% or less, Mn: 0.5% or more and 3.0% or less, P: 0.003% or more and 0.05% or less, S: 0.05% or less, Cr, 0.1% or more and 0.5% or less, Ti: 0.01% or more and 0.1% or less, Al: 1% or less, B: 0.0002% or more and 0.004% or less, N: 0.01% or less, and the balance being Fe and impurities, and contains one or two or more selected from Cu: 1% or less, Ni: 2% or less, Mo: 1% or less, V: 1% or less, and Nb: 1% or less as needed.

(Plating Film Layer)

On the surface (at least one of an inner surface and an outer surface) of the material steel pipe before subjected to 3DQ as explained above, a plating film layer containing 50 mass % or more of Al is provided. As the plating film layer, for example, a (50 to 60) mass % Al—Zn—(1 to 2.5) mass % Si—(0 to 5) mass % Mg hot-dip plating film or an Al—(0 to 15) mass % Si hot-dip plating film is exemplified.

A plating deposition amount of the (50 to 60) mass % Al—Zn—(1 to 2.5) mass % Si—(0 to 5) mass % Mg hot-dip plating film layer or the Al—(0 to 15) mass % Si hot-dip plating film layer is preferably 20 g/m² to 200 g/m² per surface from a viewpoint of sufficiently ensuring the post-coating corrosion resistance after a heat treatment. The deposition amount of the (50 to 60) mass % Al—Zn—(1 to 2.5) mass % Si—(0 to 5) mass % Mg hot-dip plating film layer or the Al—(0 to 15) mass % Si hot-dip plating film layer is more preferably 40 g/m² or more and 80 g/m² or less per surface.

Both of the plating film layers composed of the above components are excellent in plating residue at high temperature as compared with a hot-dip plated steel sheet of Zn and an alloyed hot-dip galvanized steel sheet. Note that when the plating film layer is heated as it is, the surface reacts with oxygen to form an alumina film in some cases. Therefore, an inert gas supply apparatus for shutting out oxygen from a place where the workpiece becomes high temperature ranging from an induction heating coil of the 3DQ apparatus to a cooling apparatus may be provided in the 3DQ apparatus to remove oxygen from the surface of the plating film layer which has become high temperature by an inert gas (nitrogen, argon or the like).

Note that plating performed on the material steel pipe according to this embodiment is not limited to the above (50 to 60) mass % Al—Zn—(1 to 2.5) mass % Si—(0 to 5) mass % Mg hot-dip plating or Al—(0 to 15) mass % Si hot-dip plating, but any plating can be appropriately used as long as it contains 50 mass % or more of Al.

(Surface Film Layer)

The surface of the above plating film layer may be covered by a film containing a granular metallic compound to further improve chemical conversion treatability. Hereinafter, the above film layer covering the surface of the plating film layer is called a “surface film layer”. In the material steel pipe according to this embodiment, the granular metallic compound contained in the surface film layer is preferably one or more of ZnO, Mg chemical compound, ZrO, CaO, TiO₂ or SiO₂.

<Method for Measuring a Deposition Amount of the Plating Film Layer>

A method for measuring a deposition amount of the plating film layer according to this embodiment is not particularly limited but, for example, a gravimetric method can be used for measurement. The gravimetric method is a method of obtaining a deposition amount from a difference between a weight of a plating sample having a prescribed area measured by a calibrated electronic balance and a weight after dissolution obtained by dissolving only the plating layer with a hydrochloric acid or the like containing an inhibitor.

<Method for Analyzing a Composition of an Uppermost Surface Layer of the Plating Film Layer>

The composition of an outermost layer of the plating film layer according to this embodiment can be specified as follows.

First, a test piece having a predetermined area is sampled from the material having the plating film. The outermost layer of the plating film layer is dissolved with the hydrochloric acid or the like containing the inhibitor and the dissolved solution is diluted to a predetermined volume. The concentrations of a Zn ion, an Al ion, a Si ion, a Fe ion and so on in the dissolved solution are measured by an analyzer for an ICP (high-frequency inductively coupled plasma emission spectrochemical analysis method). The ratio of the ions contained in the dissolved solution is the ratio of elements in the plating film layer. In the case of performing a heat treatment using plating mainly containing Al as a material, as interdiffusion of Al in plating and Fe being a base material proceeds during the heat treatment, a Fe—Al intermetallic compound small in concentration difference between Fe and Al is generated to make the interface between the base material and the plating unclear. Therefore, the “outermost layer” is defined as a range of dissolving with the hydrochloric acid containing the inhibitor.

<Regarding a Method for Manufacturing a Vehicle Underbody Part Material>

Subsequently, a method for manufacturing a vehicle underbody part material according to this embodiment will be explained in detail.

In the method for manufacturing the vehicle underbody part material according to this embodiment, quenching is performed on at least a part of a steel pipe including a plating film layer containing 30 mass % or more of Al to form the vehicle underbody part material. The quenching step includes, as described below in detail, a heating step and a cooing step, and hot bending is performed between the heating step and the cooling step on at least a part of the material steel pipe which has become high temperature in the heating step.

[Regarding a Usable 3DQ Apparatus]

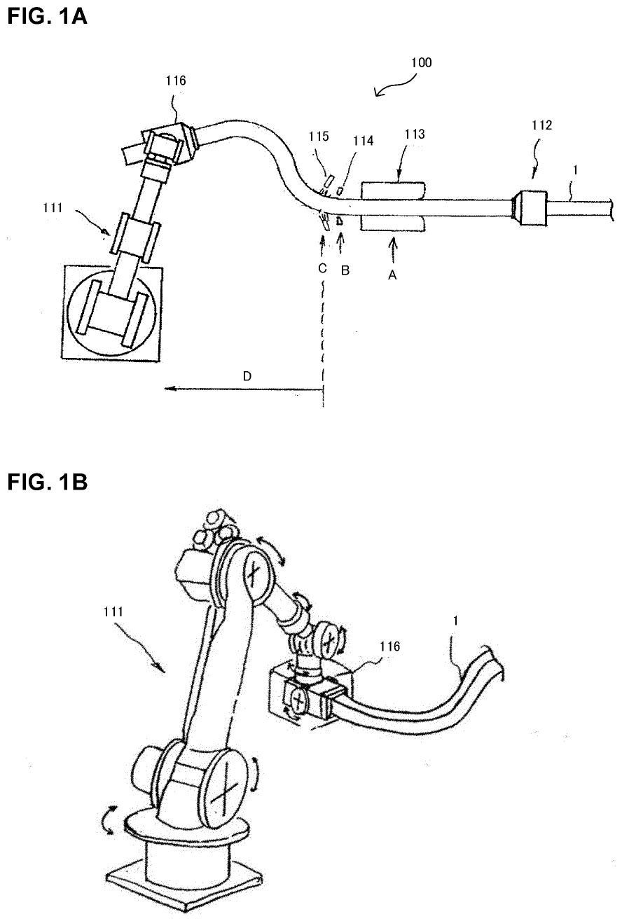

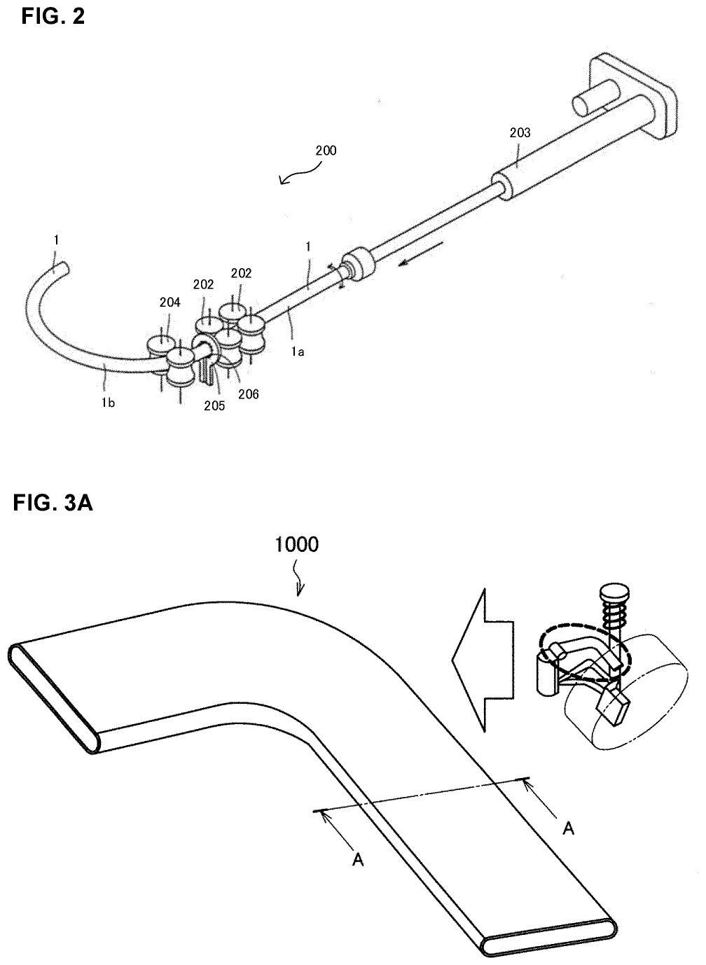

A series of the above steps are preferably performed using the 3DQ apparatus disclosed in Patent Document 1 or Patent Document 2. Hereinafter, an example of the 3DQ apparatus usable in the method for manufacturing the vehicle underbody part material according to this embodiment will be briefly explained referring to FIG. 1A to FIG. 2.

FIG. 1A and FIG. 1B illustrate the 3DQ apparatus which performs bending by an articulated robot disclosed in Patent Document 2.

In a 3DQ apparatus 100 using an articulated robot 111 as illustrated in FIG. 1A and FIG. 1B, a workpiece 1 held by a grip part 112 is supported at a first position A by a support device 113. The workpiece 1 is sent by a sending device (not illustrated) in a longitudinal direction of the workpiece. The workpiece 1 is partially heated by a high-frequency heating device 114 at a second position B on the downstream side of the first position A. Then, a portion heated at the second position B of the workpiece 1 is cooled by a cooling device 115 at a third position C on the downstream side of the second position B. Between the heating and the cooling, in a region D on the downstream side of the third position C, the articulated robot 111 changes the position of a grasping unit 116 grasping the workpiece 1 to a desired position in a three-dimensional space. This applies a bending moment to the heated portion of the workpiece 1 into a target product shape, thereby performing the bending.

Besides, FIG. 2 illustrates the 3DQ apparatus performing the bending by movable roller dies disclosed in Patent Document 1.

In a 3DQ apparatus 200 illustrated in FIG. 2, two pairs of support units (specifically, support rolls 202) for rotatably holding a workpiece 1a are provided, and an extruding device 203 which sequentially or continuously feeds and moves the workpiece 1a is provided on the upstream side of the support units. Further, on the downstream side of the two pairs of support units, movable roller dies 204 for clamping the workpiece 1a and controlling the clamp position and/or moving speed are arranged. On the input side of the movable roller dies 204, a high-frequency heating coil 205 which is arranged at an outer periphery of the workpiece 1a and locally heats the workpiece 1a and a cooling device 206 which rapidly cools the workpiece 1a are arranged.

In the 3DQ apparatus 200 illustrated in FIG. 2, while the workpiece 1a is being fed toward the longitudinal direction, a part of the workpiece 1a is heated by the high-frequency heating coil 205. Further, the heated workpiece 1a is cooled by the cooling device 206 which is adjacent to the high-frequency heating coil 205 and arranged on the downstream side thereof in the feeding direction. More specifically, the workpiece 1a has a high-temperature region in a region between the high-frequency heating coil 205 and the cooling device 206, while being fed in the longitudinal direction. A bending moment is applied to the high-temperature region of the workpiece 1a, whereby the workpiece 1a is subjected to hot bending. The high-temperature region subjected to the hot bending of the workpiece 1a is fed to the cooling device 206 and quenched to be fixed in shape. As described above, a part material 1b subjected to the hot bending into a desired shape is manufactured.

[Details of the Method for Manufacturing the Vehicle Underbody Part Material]

The method for manufacturing the vehicle underbody part material according to this embodiment performed using the above-described 3DQ apparatus will be explained in detail. The steel pipe including the plating film layer containing 30 mass % or more of Al provided on the surface (at least one of the inner surface and the outer surface) sequentially undergoes a heating step, a bending step, and a cooling step in 3DQ and is thereby formed into a vehicle underbody part material.

In the heating step, the steel pipe including the plating film layer containing 30 mass % or more of Al is heated to an Ac3 transformation point or higher. The reason why the steel pipe is heated to the Ac3 transformation point or higher is that the whole vehicle underbody part is made to cause martensitic transformation. To this end, it is necessary to heat the steel pipe to the Ac3 transformation point or higher into an austenite single phase. As a heat treatment pattern at this time, the steel pipe including the plating film layer containing 30 mass % or more of Al is heated at an average temperature increasing rate of 100° C./sec or more from 100° C. to a maximum heating temperature in a temperature range of 850 to 1300° C. in surface temperature of the plating film layer.

The case where the average temperature increasing rate is less than 100° C./sec is not preferable because the processing accuracy lowers. An increase in time required to reach the maximum heating temperature means an increase of a region softened by high temperature. In other words, a region to be deformed to bend is increased, resulting in that the degree of bending in the longitudinal direction cannot be finely adjusted any longer. Further, the case where the average temperature increasing rate is less than 1000° C./sec is not preferable because the quenching cannot be performed any longer.

The case where the maximum heating temperature is lower than 850° C. is not preferable because it is difficult for the whole vehicle underbody part to cause martensite transformation. On the other hand, a too-high heating temperature is not preferable because the crystal grain becomes coarse and the toughness is insufficient. The maximum heating temperature is preferably within a temperature range of the Ac3 transformation point to 130° C., and more preferably within a temperature range of (Ac3 transformation point+10°) C. to 1100° C.

Here, it has been revealed that when the material steel pipe including the plating film layer containing 50 mass % or more of Al as explained above is subjected to the heating step in which heating is performed by high-frequency heating, depressions and projections occur on the surface of the plating film layer after heating. In an investigation of the cause of the occurrence of the depressions and projections, the cause is the interaction between melted Al in a liquid phase and a high-frequency electromagnetic field, and when the melted Al in a liquid phase and a high-frequency electromagnetic field coexist, depressions and projections inevitably occur.

When the material steel pipe with depressions and projections occurring on the surface is subjected to 3DQ, the depressions and projections remain also on a surface of a vehicle underbody part material to be manufactured. At the depressions of the depressions and projections existing on the surface, the plating film layer is considered to be thin. On the hand, the Al plating does not exhibit the corrosion resistance by sacrifice corrosion protection but holds the corrosion resistance by the film itself. Therefore, there is a concern that the portion where the plating film layer is thin in the depression decreases in corrosion resistance, possibly influencing the reliability of the vehicle underbody part material. Further, the vehicle underbody part material having the surface on which the depressions and projections remain is lowered also in good appearance.

One of conceivable methods for suppressing the occurrence of the depressions and projections is a method of decreasing the temperature increasing rate of the high-frequency heating in the heating step. The decreasing the temperature increasing rate promotes the interdiffusion of Fe in the steel pipe being the base material and Al in the plating film layer during the heating, thereby forming a high-melting point Al—Fe intermetallic compound (Al—Fe alloy). The formation of the high-melting point Al—Fe alloy cancels the coexistence of the melted Al and the high-frequency electromagnetic field and suppresses the occurrence of the depressions and projections on the surface. However, the decreasing the temperature increasing rate in the heating step may result in a decrease in production efficiency and may enlarge the heating range to result in a decrease in processing accuracy.

Another conceivable method for suppressing the occurrence of the depressions and projections is a method of preheating the material steel pipe including the plating film layer containing 50 mass % or more of Al by a heating method other than the high-frequency (for example, radiation heating in a muffle electric furnace or infrared furnace heating). The preheating causes interdiffusion of Fe in the steel pipe being the base material and Al in the plating film layer, and a high-melting point Al—Fe alloy is formed up to the surface of the plating film layer and then subjected to the high-frequency heating. In this case, the heating temperature only needs to cause interdiffusion of Fe and Al, so that it is possible to select an arbitrary temperature according to the usable heating method and time. However, for the heating method, a method other than the high-frequency heating is employed as explained above in order to prevent the occurrence of the depressions and projections on the surface.

For example, in the case of using the material steel pipe including the plating film layer containing 50 mass % or more of Al as explained above in detail, it is preferable to heat the material steel pipe in a furnace to 750° C. or higher and 900° C. or lower to form the Al—Fe alloy. The temperature of the furnace heating is more preferably 800° C. or higher and 890° C. or lower. Note that though the holding time in the furnace heating is not particularly limited, the holding time in the case of using a furnace at 900° C. is about 5 minutes or less.

Al—Fe alloy phases formed under a normal preheating condition are FeAl₃, Fe₂Al₅, FeAl₂, and FeAl, and these Al—Fe alloy phases never change depending on the cooling rate after the preheating. When the preheating temperature is 1102 to 1232° C., Al_{0.6}Fe_{0.4} (ε phase) may arise as the Al—Fe alloy phase. The ε phase changes to FeAl₂ and FeAl during slow cooling, but even if it changes, it is still a high-melting point Al—Fe alloy phase. Besides, even when the base material structure becomes a quenched structure or not, the base material hardness after the high-frequency heating is nor affected and can therefore be set to an arbitrary value.

By the preheating step as explained above, the Al—Fe alloy is generated up to the surface of the plating film layer. The Al—Fe alloy is preferably at least one of FeAl, Fe_{0.4}Al_{0.6} (ε phase), FeAl₂, Fe₂Al₅, and FeAl₃ as explained above.

In the case of using the material steel pipe including the plating film layer containing 50 mass % or more of Al, performing the preheating step as explained above prior to the heating step can suppress the occurrence of the depressions and projections on the surface. As a result of this, the surface roughness of the surface of the plating film layer can be set to 3.5 μm or less in arithmetic mean roughness Ra specified under JIS B0601: 2013. This makes it possible to prevent a decrease in corrosion resistance of the vehicle underbody part material to be manufactured and keep also the good appearance.

Note that the surface roughness Ra of the surface of the plating film layer can be measured by a commercially available roughness meter (for example, Surfcom 1900DX, stylus model E-DT-SS01A, manufactured by TOKYO SEIMITSU CO., LTD.) conforming to the above JIS standard. In this event, the measuring direction is a circumferential direction of a pipe.

The detailed kind of the Al—Fe alloy can be specified by measuring an XRD (X-ray diffraction measurement) pattern of a test material. Generally, when not limited to the Fe—Al alloy phase but a certain phase exists, a plurality of diffraction intensity peaks appear. The positions of the diffraction intensity peaks can be predicted from a JCPDS card of the phase. The XRD pattern of the test material is confirmed, and if peaks are actually confirmed at all of a plurality of positions where the peaks of a certain phase appear, the phase is considered to exist in an X-ray irradiating range of the test material. For example, Al is XRD-measured by a Co tube, peaks appear at 2θ=45.03 degrees, 52.48 degrees, 77.40 degrees, and 94.31 degrees. When there are peaks at all of the positions of the XRD pattern of the test material, the test material is determined to contain the Al phase.

In 3DQ, a bending moment is applied to at least a part of the steel pipe having reached the maximum heating temperature to perform hot bending. Within two seconds after the part of the steel pipe has reached the maximum heating temperature, the cooling step is started. In the cooling step, the steel pipe is cooled at a cooling rate of 1000° C./sec or more on average from the maximum heating temperature to an ultimate temperature of 350° C. or lower.

The time period from when the steel pipe is heated to 850° C. or higher to when the cooling is started is within two seconds. In other words, the time period from when the steel pipe is heated to 850° C. or higher to when coolant (cooling water) comes into contact with the material steel pipe is within two seconds. When the time period during which the steel pipe is at 850° C. or higher increases, the plating film layer evaporates or the intermetallic compound with an unintentional iron is produced, resulting in a problem of a decrease in corrosion resistance.

The plating film layer of the steel pipe subjected to 3DQ is a plating film layer containing 30 mass % or more of Al. Even in the case of using the steel pipe including the plating film layer containing 50 mass % or more of Al (for example, a (50 to 60) mass % Al—Zn—(0 to 2.5) mass % Si—(0 to 5) mass % Mg hot-dip plating film or an Al—(0 to 15) mass % Si hot-dip plating film), a Fe—Zn intermetallic compound (a so-called ζ phase, δ₁ phase, Γ phase or the like) does not exist in the plating film layer of the vehicle underbody part material to be manufactured. This is because Zn does not exist in the Al—(0 to 15) mass % Si hot-dip plating, and because a heating temperature of exceeding 900° C. is higher than the melting point or the decomposition temperature of one of the ζ phase (FeZn₁₃), the δ₁ phase (FeZn₇), the Γ₁ phase (Fe₅Zn₂₁), and the Γ phase (Fe₃Zn₁₀) which are the Fe—Zn intermetallic compound in the (50 to 60) mass % Al—Zn—(0 to 2.5) mass % Si—(0 to 5) mass % Mg hot-dip plating and these layers are therefore decomposed during heating.

In the method for manufacturing the vehicle underbody part material according to this embodiment, a method high in practical value will be exemplified. The material steel pipe having the (50 to 60) mass % Al—Zn—(0 to 2.5) mass % Si—(0 to 5) mass % Mg hot-dip plating film layer on one or both of the inner surface and the outer surface is used as a workpiece being a long member for a vehicle, and subjected to bending after the quenching or heating or simultaneously subjected to the quenching and the bending by 3DQ to thereby manufacture the vehicle underbody part material according to this embodiment.

The method for manufacturing the vehicle underbody part material according to this embodiment has been explained in detail referring to FIG. 1A to FIG. 2.

<Regarding the Vehicle Underbody Part Material>

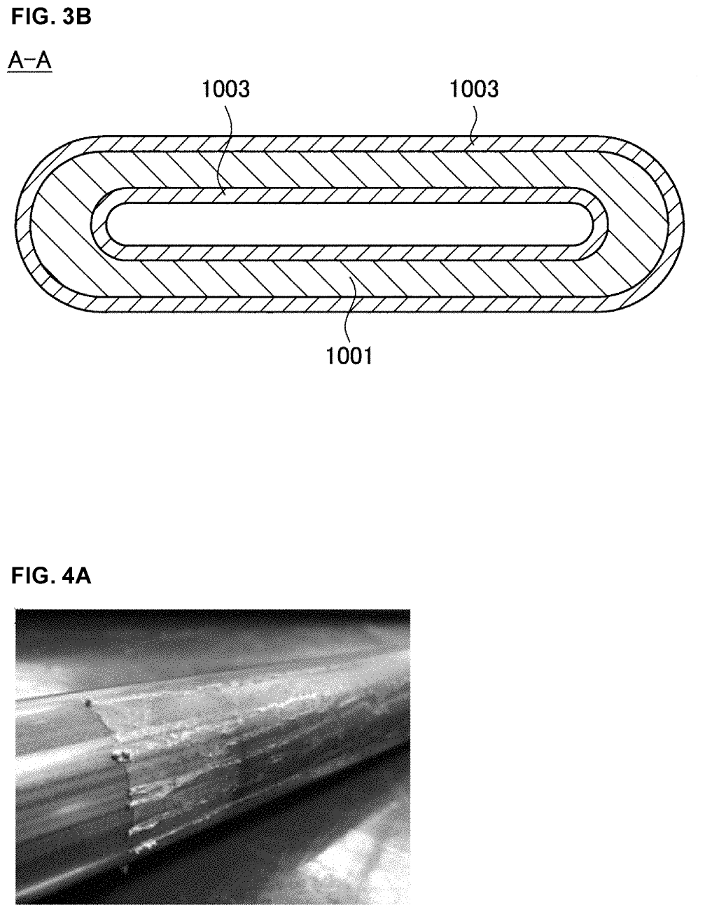

Subsequently, the vehicle underbody part material manufactured by the method for manufacturing the vehicle underbody part material as explained above will be explained in detail referring to FIG. 3A and FIG. 3B. FIG. 3A is an explanatory view illustrating the vehicle underbody part material according to this embodiment. FIG. 3B is an explanatory view illustrating a cross-sectional structure of the vehicle underbody part material according to this embodiment.

The vehicle underbody part mentioned here is a part constituting a suspension or a sub-frame. Specifically, an upper frame, a lower arm, a torsion beam, a stabilizer and so on are exemplified. Those parts are important safety-related parts and required to have fatigue resistance and corrosion resistance.

The vehicle underbody part material according to this embodiment is manufactured by performing the specific quenching step as explained above using the above-explained predetermined steel pipe. More specifically, a vehicle underbody part material 1000 according to this embodiment is composed of a bent steel pipe as schematically illustrated in FIG. 3A. FIG. 3B illustrates a cross-sectional structure when the vehicle underbody part material 1000 illustrated in FIG. 3A is cut along an A-A cutting line. The vehicle underbody part material 1000 according to this embodiment includes, as illustrated in FIG. 3B, a quenched and bent steel pipe 1001, and a plating film layer 1003 provided on the surface of the steel pipe 1001 and containing 30 mass % or more of Al and having an Al—Fe alloy existing in a surface thereof. Further, in the vehicle underbody part material 1000 according to this embodiment, the plating film layer 1003 may be provided also on an inner surface of the steel pipe 1001. Note that the shape of the vehicle underbody part material 1000 according to this embodiment is not limited to the example illustrated in FIG. 3A but may have an arbitrary shape.

The steel pipe 1001 included in the vehicle underbody part material 1000 is a quenched structure in which the base material structure has a martensite structure by quenching. The quenched part of the vehicle underbody part material 1000 exhibits the characteristics explained below in detail.

The part subjected to quenching of the vehicle underbody part material 1000 according to this embodiment is subjected to measurement of the content of each element from the uppermost surface of the quenched part toward the deep part down to a depth of 0.1 μm from the uppermost surface by the glow discharge spectroscopy (GDS) or the like. In this case, the content (average content) of the elements other than oxygen in the measurement range is Al: 20% or less by mass %.

The plating film layer 1003 included in the vehicle underbody part material 1000 according to this embodiment contains 30 mass % or more of Al and has an Al—Fe alloy existing in a surface thereof. Specifically, the outermost layer of the plating film layer 1003 of the vehicle underbody part material 1000 preferably has a plating composition composed of (30 to 60) mass % Al—Zn—(0 to 2.5) mass % Si—(0 to 5) mass % Mg—(20 to 50) mass % Fe hot-dip plating or Al—(0 to 15) mass % Si—(20 to 70) mass % Fe hot-dip plating. Further, at least one of FeAl, Fe_{0.4}Al_{0.6} (E phase), FeAl₂, Fe₂Al₅, and FeAl₃ preferably exists, as the Al—Fe alloy, on the outermost layer of the plating film layer 1003.

Note that the structure of the outermost layer of the plating film layer 1003 can be analyzed by the same method as that of the analyzing method for the structure of the outermost layer of the plating film layer included in the material steel pipe. Similarly, the kind of the Al—Fe alloy can be specified by the same method as the specifying method for the kind of the Al—Fe alloy in the material steel pipe after the preheating.

The surface roughness of the plating film layer 1003 of the vehicle underbody part material 1000 is preferably 3.5 μm or less in arithmetic mean roughness Ra specified under JIS B0601: 2013. The vehicle underbody part material 1000 has the surface roughness, whereby its corrosion resistance is more surely guaranteed and its good appearance can be maintained. The surface roughness can be measured, as in the same manner with the surface roughness in the material steel pipe, by the above-explained commercially available roughness meter (for example, Surfcom 1900DX, stylus model E-DT-SS01A, manufactured by TOKYO SEIMITSU CO., LTD.) conforming to the JIS standard.

The weight of the plating film layer 1003 of the vehicle underbody part material 1000 is preferably 32 g/m² to 600 g/m². Further, the Fe content of the plating film layer 1003 is preferably 20% to 70% to the total mass of the plating film layer 1003 as explained above. The weight of the plating film layer 1003 of the vehicle underbody part material 1000 according to this embodiment is more preferably 45 g/m² to 320 g/m², and the Fe content of the plating film layer 1003 is more preferably 30% to 60%.

The vehicle underbody part material relating to this disclosure only needs to have at least a part of the steel pipe satisfying the conditions specified in this disclosure. For example, a case of the vehicle underbody part material relating to this disclosure assumed as a bent member of a vehicle as a use thereof will be considered. In this case, even if a region subjected to hot bending and quenching has been quenched as a whole, all regions of the member do not need to be subjected to the bending and quenching. For example, the steel pipe even having, at an end portion, a portion where neither the bending nor the quenching are performed, is an object of the vehicle underbody part material relating to this disclosure. A portion not subjected to quenching can be used as a hole opening portion or a welding portion in manufacturing the vehicle underbody part. In other words, if satisfying the conditions specified in this disclosure only for a surface or portion particularly important as a member, the member is included in the vehicle underbody part material relating to this disclosure.

The vehicle underbody part material according to this embodiment has been explained above in detail.

<Regarding the Vehicle Underbody Part>

The vehicle underbody part can be manufactured by using the above-explained vehicle underbody part material according to this embodiment or the vehicle underbody part material manufactured by the above-explained method for manufacturing the vehicle underbody part material. The above-explained vehicle underbody part material according to this embodiment is extremely excellent in fatigue failure resistance. Therefore, by manufacturing the vehicle underbody part using the vehicle underbody part material, a vehicle underbody part suppressed in occurrence of fatigue failure and excellent in durability can be obtained even though vibration is constantly applied to the vehicle underbody part. Examples of the vehicle underbody part include, but not particularly limited to, an upper arm, a lower arm, a torsion beam, a stabilizer and so on.

### EXAMPLES

Hereinafter, the vehicle underbody part material, the method for manufacturing the vehicle underbody part material, and the method for manufacturing the vehicle underbody part relating to this disclosure will be concretely explained while illustrating examples and comparative examples. Note that the examples illustrated below are merely examples of the vehicle underbody part material, the method for manufacturing the vehicle underbody part material, and the method for manufacturing the vehicle underbody part relating to this disclosure. The vehicle underbody part material, the method for manufacturing the vehicle underbody part material, and the method for manufacturing the vehicle underbody part relating to this disclosure are not limited to the following examples.

### Test Example 1

### (Material Steel Pipe)

In this test example, various kinds of plated steel sheets listed in the following Table 1 using, as a plating base material, a steel sheet having a chemical composition including C: 0.22%, Si: 0.21%, Mn: 1.25%, P: 0.012%, S: 0.002%, Al: 0.040%, Cr: 0.25%, Ti: 0.030%, B: 0.0015, and the balance Fe and impurities, were used as a steel material and both ends of the plated steel sheets were welded to form welded steel pipes. The obtained welded steel pipes were used as material steel pipes. The plating species used here in this test example are as follows. Note that weights per one surface are additionally described below for the respective plating species.

Zn—55 mass % Al—1.6 mass % Si hot dipping (weight: 70 g/m²)

Zn—55 mass % Al—2.5 mass % Si hot dipping (weight: 60 g/m²)

Zn—60 mass % Al—1.6 mass % Si hot dipping (weight: 100 g/m²)

Zn—55 mass % Al—1.6 mass % Si-2 mass % Mg hot dipping (weight: 90 g/m²)

Zn—55 mass % Al—1.6 mass % Si-5 mass % Mg hot dipping (weight: 100 g/m²)

Al—0 mass % Si hot dipping (weight: 50 g/m²)

Al—5 mass % Si hot dipping (weight: 70 g/m²)

Al—10 mass % Si hot dipping (weight: 70 g/m²)

Al—15 mass % Si hot dipping (weight: 70 g/m²)

(Manufacture of the Vehicle Underbody Part Material)

As the preheating treatment, the prepared material steel pipes were held for 5 minutes in the muffle electric furnace in an air atmosphere kept at a furnace temperature of 900° C., and then taken out to the atmosphere and made to stand to cool. Thereafter, the material steel pipes were heated from 100° C. to the maximum heating temperatures listed in Table 1 at an average temperature increasing rate of 300° C./sec by the manufacturing apparatus 100 as illustrated in FIG. 1A and FIG. 1B and kept for 0.1 seconds, and immediately thereafter subjected to water cooling. In this event, the bending was performed before the start of the above cooling on parts of the above test materials. Note that all of average cooling rates from the maximum heating temperatures to 350° C. were 1000° C./sec or more.

The vehicle underbody part materials (Nos. 1 to 19) were produced as explained above, and evaluated in fatigue failure characteristics as follows.

Further, for each of the obtained vehicle underbody part materials, the above-explained method was used to analyze the uppermost surface layer of the plating film layer to thereby specify the plating composition of the uppermost surface layer and the kind of the Al—Fe alloy. Further, the surface roughness of the obtained vehicle underbody part material was measured by the commercially available roughness meter (Surfcom 1900DX, stylus model E-DT-SS01A, manufactured by TOKYO SEIMITSU CO., LTD.) according to the above method.

(Evaluation Method)

Regarding the fatigue failure characteristics, a plane bending fatigue test piece was cut out of the test material and a stress of 600 MPa was applied thereon 1.5 million times. The test piece broken in the middle and the test piece in which a crack was recognized in observation under a cross-section SEM after the test were regarded as fail, and the test piece in which both of the break and the crack were not recognized was regarded as pass. ∘ was marked for pass in a column of “fatigue characteristics” of Table 1 illustrated below, whereas x was marked for fail. Note that the observation under the cross-section SEM was performed as follows. More specifically, a sample for observation was cut out and sampled from the test material, embedded in a resin, and subjected to mirror polishing, and then subjected to gold deposition without etching. The obtained sample for observation was photographed under SEM at an acceleration voltage of 15 kV at a magnitude of 3000 times.

TABLE 1

| | | | VEHICLE UNDERBODY PART MATERIAL | |
|---|---|---|---|---|
| | MATERIAL STEEL | 3 DQ | PRESENCE OF | |
| | PIPE PLATING | TEMPERATURE | QUENCHED | |
| No. | SPECIES | [° C.] | STRUCTURE | PLATING COMPOSITION |
| 1 | Zn—55Al—1.6Si | 1000 | ○ | 24.1%Zn—33.0%Al—42.1%Fe—0.8%Si |
| 2 | Zn—55Al—1.6Si | 1100 | ○ | 22.8%Zn—31.2%Al—45.2%Fe—0.8%Si |
| 3 | Al—10Si | 1100 | ○ | 37.1%Al—3.7%Si—59.3%Fe |
| 4 | Al—10Si | 1000 | ○ | 45.5%Al—4.5%Si—50.0%Fe |
| 5 | NO | 1100 | ○ | NO |
| 6 | Al—0Si | 1100 | ○ | 33.3%Al—63.3%Fe—3.3%Si |
| 7 | Al—5Si | 1100 | ○ | 35.7%Al—60.7%Fe—3.6%Si |
| 8 | Al—15Si | 1100 | ○ | 41.7%Al—54.2%Fe—4.2%Si |
| 9 | Zn—55Al—2.5Si | 1100 | ○ | 23.6%Zn—31.9%Al—43.6%Fe—0.9%Si |
| 10 | Zn—60Al—1.8Si | 1100 | ○ | 22.2%Zn—30.1%Al—46.9%Fe—0.9%Si |
| 11 | Al—55Al—1.6Si—2Mg | 1100 | ○ | 24.2%Zn—32.7%Al—40.4%Fe—1.5%Si—1.2%Mg |
| 12 | Al—55Al—1.6Si—5Mg | 1100 | ○ | 25.3%Al—34.3%Al—35.7%Fe—1.6%Si—3.1%Mg |
| 13 | A—0Si | 1000 | ○ | 38.5%Al—57.7%Fe—3.8%Si |
| 14 | Al—5Si | 1000 | ○ | 41.7%Al—54.2%Fe—4.2%Si |
| 15 | Al—15Si | 1000 | ○ | 50.0%Al—45.0%Fe—5.0%Si |
| 16 | Zn—55Al—2.5Si | 1000 | ○ | 26.2%Zn—35.4%Al—36.8%Fe—1.6%Si |
| 17 | Zn—60Al—1.6Si | 1000 | ○ | 24.6%Zn—33.3%Al—41.1%Fe—1.0%Si |
| 18 | Al—55Al—1.6Si—2Mg | 1000 | ○ | 25.4%Zn—34.4%Al—38.0%Fe—1.0%Si—1.3%Mg |
| 19 | Al—55Al—1.6Si—5Mg | 1000 | ○ | 28.0%Zn—37.9%Al—29.5%Fe—1.1%Si—3.4%Mg |
| | VEHICLE UNDERBODY PART MATERIAL | | | |
| | AL—Fe | Ra | FATIGUE | |
| No. | ALLOY KIND | [μm] | CHARACTERISTICS | NOTE |
| 1 | FeAl₂, Fe₂Al₅, Zn, ZnO | 1.27 | ○ | EXAMPLE |
| 2 | Fe_{0.4}Al_{0.8}, Zn, ZnO | 1.58 | ○ | EXAMPLE |
| 3 | Fe_{0.4}Al_{0.8} | 1.56 | ○ | EXAMPLE |
| 4 | FeAl₃, Fe₂Al₅ | 1.33 | ○ | EXAMPLE |
| 5 | NO | — | x | COMPARATIVE EXAMPLE |
| 6 | Fe_{0.4}Al_{0.6} | 1.47 | ○ | EXAMPLE |
| 7 | Fe_{0.4}Al_{0.6} | 1.62 | ○ | EXAMPLE |
| 8 | Fe_{0.4}Al_{0.6} | 1.55 | ○ | EXAMPLE |
| 9 | Fe_{0.4}Al_{0.6}, Zn, ZnO | 1.59 | ○ | EXAMPLE |
| 10 | Fe_{0.4}Al_{0.6}, Zn, ZnO | 1.66 | ○ | EXAMPLE |
| 11 | Fe_{0.4}Al_{0.6}, Zn, ZnO | 1.54 | ○ | EXAMPLE |
| 12 | Fe_{0.4}Al_{0.6}, Zn, ZnO | 1.67 | ○ | EXAMPLE |
| 13 | FeAl₃, Fe₂Al₅ | 1.46 | ○ | EXAMPLE |
| 14 | FeAl₃, Fe₂Al₅ | 1.33 | ○ | EXAMPLE |
| 15 | FeAl₃, Fe₂Al₅ | 1.33 | ○ | EXAMPLE |
| 16 | FeAl₃, Fe₂Al₅, Zn, ZnO | 1.29 | ○ | EXAMPLE |
| 17 | FeAl₃, Fe₂Al₅, Zn, ZnO | 1.27 | ○ | EXAMPLE |
| 18 | FeAl₃, Fe₂Al₅, Zn, ZnO | 1.32 | ○ | EXAMPLE |
| 19 | FeAl₃, Fe₂Al₅, Zn, ZnO | 1.34 | ○ | EXAMPLE |

As is clear from the above Table 1, the test materials corresponding to the examples of this disclosure were pass in fatigue failure characteristics. Comparative Example No. 5 in which no plating film layer existed was fail in fatigue failure characteristics.

### Test Example 2

Various kinds of plated steel sheets listed in the following Table 2 using, as a plating base material, a steel sheet having the same chemical composition as that in the above Test Example 1 were used and both ends of the plated steel sheets were welded to form welded steel pipes. The obtained welded steel pipes were used as material steel pipes. Here, the plating species used in this test example are as follows.

Zn—55 mass % Al—1.6 mass % Si hot dipping (weight: 70 g/m²)

Zn—55 mass % Al—1.6 mass % Si-2 mass % Mg hot dipping (weight: 90 g/m²)

Al—0 mass % Si hot dipping (weight: 50 g/m²)

Al—5 mass % Si hot dipping (weight: 70 g/m²)

Al—10 mass % Si hot dipping (weight: 70 g/m²)

As the preheating treatment, the prepared material steel pipes were held for 5 minutes in the muffle electric furnace in an air atmosphere kept at a furnace temperature of 900° C., and then taken out to the atmosphere and made to stand to cool. Further, for comparison, material steel pipes on which the preheating was not executed were also prepared. Thereafter, the material steel pipes were heated from 100° C. to the maximum heating temperature listed in Table 2 at an average temperature increasing rate 300° C./sec by the manufacturing apparatus 100 as illustrated in FIG. 1A and FIG. 1B and kept for 0.1 seconds, and immediately thereafter subjected to water cooling. In this event, the bending was performed before the start of the above cooling on parts of the above test materials. Note that all of average cooling rates from the maximum heating temperature to 350° C. were 1000° C./sec or more.

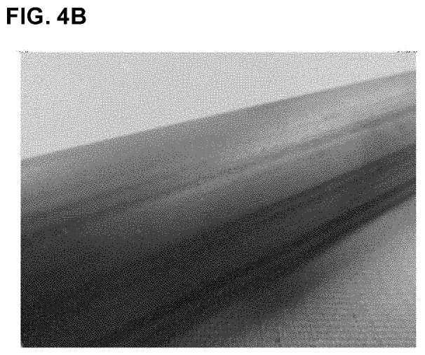

The vehicle underbody part materials (Nos. 1 to 10) were produced as explained above, and evaluated as in Test Example 1. The obtained results are collectively listed in the following Table 2. Besides, photographs of the external appearances of the vehicle underbody part materials of No. 3 and No. 8 in Table 2 are illustrated in FIG. 4A and FIG. 4B.

TABLE 2

| | | | | VEHICLE UNDERBODY PART MATERIAL | |
|---|---|---|---|---|---|
| | MATERIAL STEEL | EXECUTION | 3 DQ | PRESENCE OF | |
| | PIPE PLATING | OF | TEMPERATURE | QUENCHED | |
| No. | SPECIES | PREHEATING | [° C.] | STRUCTURE | PLATING COMPOSITION |
| 1 | Al—0Si | NO | 1000 | ○ | 60.8%Al—32.0%Fe—7.2%Si |
| 2 | Al—5Si | NO | 1000 | ○ | 60.2%Al—32.9%Fe—6.9%Si |
| 3 | Al—10Si | NO | 1000 | ○ | 63.0%Al—29.5%Fe—7.5%Si |
| 4 | Zn—55Al—1.6Si | NO | 1000 | ○ | 21.9%Zn—47.5%Al—28.7%Fe—1.9%Si |
| 5 | Zn—55Al—1.6Si—2Mg | NO | 1000 | ○ | 34.1%Zn—45.3%Al—17.7%Fe—1.2%Si—1.6%Mg |
| 6 | Al—0Si | YES | 1000 | ○ | 38.5%Al—57.7%Fe—3.8%Si |
| 7 | Al—5Si | YES | 1000 | ○ | 41.7%Al—54.2%Fe—4.2%Si |
| 8 | Al—10Si | YES | 1000 | ○ | 45.5%Al—4.5%Si—50.0%Fe |
| 9 | Zn—55Al—1.6Si | YES | 1000 | ○ | 24.1%Zn—33.0%Al—42.1%Fe—0.8%Si |
| 10 | Zn—55Al—1.6Si—2Mg | YES | 1000 | ○ | 25.4%Zn—34.4%Al—38.0%Fe—1.0%Si—1.3%Mg |
| | | VEHICLE UNDERBODY PART MATERIAL | | FATIGUE | |
| | | AL—Fe | Ra | CHARAC- | |
| | No. | ALLOY KIND | [μm] | TERISTICS | NOTE |
| | 1 | Al, Fe₂Al₅ | 14.6 | ○ | EXAMPLE |
| | 2 | Al, Fe₂Al₅ | 16.6 | ○ | EXAMPLE |
| | 3 | Al, Fe₂Al₅ | 8.5 | ○ | EXAMPLE |
| | 4 | Zn, Al, Fe₂Al₅ | 12.2 | ○ | EXAMPLE |
| | 5 | Zn, Al, Fe₂Al₅ | 15.9 | ○ | EXAMPLE |
| | 6 | FeAl₂, Fe₂Al₅ | 1.39 | ○ | EXAMPLE |
| | 7 | FeAl₂, Fe₂Al₅ | 1.31 | ○ | EXAMPLE |
| | 8 | FeAl₃, Fe₂Al₅, Zn, ZnO | 1.36 | ○ | EXAMPLE |
| | 9 | FeAl₃, Fe₂Al₅, Zn, ZnO | 1.29 | ○ | EXAMPLE |
| | 10 | FeAl₃, Fe₂Al₅, Zn, ZnO | 1.34 | ○ | EXAMPLE |

As one example is illustrated in FIG. 4A, when the material steel pipe on which the preheating was not executed was subjected to 3DQ, depressions and projections occurred on the surface of the obtained vehicle underbody part material, resulting in that the surface roughness Ra was a value exceeding 3.5 μm. On the other hand, as one example is illustrated in FIG. 4B, when the material steel pipe on which the preheating was executed was subjected to 3DQ, no depressions and projections occurred on the surface of the obtained vehicle underbody part material, resulting in that the surface roughness Ra was 3.5 μm or less.

Preferred embodiments of this disclosure have been described above in detail with reference to the accompanying drawings, but this disclosure is not limited to the embodiments. It should be understood that various changes and modifications are readily apparent to those skilled in the art to which this disclosure belongs within the scope of the technical idea as set forth in claims, and those should also be covered by the technical scope of the present invention.

### EXPLANATION OF CODES

1, 1a workpiece
1b part material
100, 200 3DQ apparatus
111 articulated robot
112 grip part
113 support device
114 high-frequency heating device
115 cooling device
116 grasping unit
202 support roll
203 extruding device
204 movable roller dies
205 high-frequency heating coil
206 cooling device
1000 vehicle underbody part material
1001 steel pipe
1003 plating film layer

1. A vehicle underbody part material comprising:
a quenched and bent steel pipe; and
a plating film layer provided on a surface of the steel pipe and containing 30 mass % or more of Al and having an Al—Fe alloy existing in a surface thereof.

2. The vehicle underbody part material according to claim 1,
wherein a surface roughness of the plating film layer is 3.5 μm or less in arithmetic mean roughness Ra specified under JIS B0601: 2013.

3. The vehicle underbody part material according to claim 1,
wherein an outermost layer of the plating film layer is composed of (30 to 60) mass % Al—Zn—(0 to 2.5) mass % Si—(0 to 5) mass % Mg—(20 to 50) mass % Fe hot-dip plating.

4. The vehicle underbody part material according to claim 1,
wherein an outermost layer of the plating film layer is composed of Al—(0 to 15) mass % Si—(20 to 70) mass % Fe hot-dip plating.

5. The vehicle underbody part material according to claim 1,
wherein the Al—Fe alloy is at least one of FeAl, Fe_{0.4}Al_{0.6}, FeAl₂, Fe₂Al₅, and FeAl₃.

6. A method for manufacturing a vehicle underbody part material comprising:
heating a part of a steel pipe comprising a plating film layer containing 30 mass % or more of Al in a surface thereof at an average temperature increasing rate of 100° C./sec or more from 100° C. to a maximum heating temperature in a range of 850 to 1300° C.;
bending a part of the steel pipe having reached the maximum heating temperature; and
cooling the part of the steel pipe at an average cooling rate of 1000° C./sec or more and to an ultimate temperature of 350° C. or lower within two seconds after the part of the steel pipe has reached the maximum heating temperature.

7. The method for manufacturing the vehicle underbody part material according to claim 6,
wherein the plating film layer has an Al—Fe alloy existing in the surface thereof.

8. The method for manufacturing the vehicle underbody part material according to claim 7,
wherein an outermost layer of the plating film layer is composed of (30 to 60) mass % Al—Zn—(1 to 2.5) mass % Si—(0 to 5) mass % Mg—(20 to 50) mass % Fe hot-dip plating.

9. The method for manufacturing the vehicle underbody part material according to claim 7,
wherein an outermost layer of the plating film layer is composed of Al—(0 to 15) mass % Si—(20 to 70) mass % Fe hot-dip plating.

10. The method for manufacturing the vehicle underbody part material according to claim 7,
wherein the Al—Fe alloy is produced by heating, in a furnace, a material steel pipe comprising a plating film layer containing 50 mass % or more of Al to 750° C. or higher and 900° C. or lower.

11. The method for manufacturing the vehicle underbody part material according to claim 10,
wherein an outermost layer of the plating film layer of the material steel pipe is composed of (50 to 60) mass % Al—Zn—(1 to 2.5) mass % Si—(0 to 5) mass % Mg hot-dip plating.

12. The method for manufacturing the vehicle underbody part material according to claim 10,
wherein an outermost layer of the plating film layer of the material steel pipe is composed of Al—(0 to 15) mass % Si hot-dip plating.

13. The method for manufacturing the vehicle underbody part material according to claim 7,
wherein the Al—Fe alloy is at least one of FeAl, Fe_{0.4}Al_{0.6}, FeAl₂, Fe₂Al₅, and FeAl₃.

14. A method for manufacturing a vehicle underbody part of manufacturing the vehicle underbody part from the vehicle underbody part material according to claim 1.

15. A method for manufacturing the vehicle underbody part material manufactured by the method for manufacturing the vehicle underbody part material according to claim 6.
